(19) United States
(12) Patent Application Publication
(10) Pub. No.: US 2011/0082721 A1
(43) Pub. Date: Apr. 7, 2011

(54) AUTOMATED REACTIVE BUSINESS PROCESSES

(75) Inventors: Majeed M. Arni, Austin, TX (US); Peter A. Coldicott, Jonestown, TX (US); Eduardo T. Kahan, Longwood, FL (US); Mei Y. Selvage, Pocatello, ID (US)

(73) Assignee: INTERNATIONAL BUSINESS MACHINES CORPORATION, Armonk, NY (US)

(21) Appl. No.: 12/572,475

(22) Filed: Oct. 2, 2009

(51) Int. Cl. G06Q 10/00; G06F 15/16

(52) U.S. Cl. 705/7.38; 709/206; 705/7.11

(57) ABSTRACT

A computer implemented method, data processing system, and computer usable program code for managing reactive business processes. In one embodiment, the computer implemented method provides for modeling a set of business processes as pre-defined events in a software process application, wherein the software process application is located on a data processing system. A set of performance indicators are associated to the set of business processes. A set of reactive business processes are modeled, wherein the set of reactive business processes are pre-defined templates included in the software process application. The set of reactive business processes are mapped to the set of performance indicators. The set of performance indicators are monitored and responsive to a trigger from the set of performance indicators, a reactive business process is initiated.

### CROSS-REFERENCE TO RELATED APPLICATIONS

The present Application is related to the following co-pending applications: U.S. patent application Ser. No. 12/507,205, filed on Jul. 22, 2009, to Arni et al., entitled “SYSTEM FOR MANAGING EVENTS IN A CONFIGURATION OF SOA GOVERNANCE COMPONENTS”, and U.S. patent application Ser. No. 12/502,010, filed on Jul. 13, 2009, to Arni et al., entitled “SERVICE ORIENTED ARCHITECTURE GOVERNANCE USING A TEMPLATE, all assigned to the present assignee, and all incorporated herein by reference.

### BACKGROUND

The disclosure relates generally to a computer implemented method, computer program product, and data processing system for automatically managing a set of reactive business processes. More specifically, the disclosure is related to an automated system for defining and monitoring a set of defined reactive business processes in a services oriented architecture.

Currently, businesses and other entities face a myriad of business requirements and possess unique individual challenges. Each business tailors their business structure to a set of products and/or services offered by the business. Performance indicators, as used herein, refer to a set of values used as a measure to determine whether a threshold level has been met for some product or process. Businesses often use performance indicators to better manage performance issues related to the business. Performance indicators are also commonly used in analysis and review to determine which areas in a business may be improved upon or corrected.

Performance indicators may be numeric values that correspond to a certain category. The numeric values provide a threshold target for compliance by a process or product. Performance indicators may be inputted into a database or software application for business users to compare figures and collect data regarding the corresponding item being evaluated. It should be noted that businesses may also utilize performance indicators for not only failures, but successful achievements of target values. Thus, performance indicators allow for records to be established to monitor various components of a business, including both its successes and failures.

While current solutions recognize the benefits of utilizing performance Key Performance Indicators (KPI), the currently available solutions for responding to a failure to meet the performance indicator targets are largely inadequate. Oftentimes, businesses must rely on multiple datasheets located on multiple databases for responding to a failure to meet the performance indicator targets. The available applications may be hardcoded and do not allow for customization to better suit the needs of the business. Missing inefficiencies in business processes are expensive both in cost and satisfaction to the stakeholders of the process. While business process automation is somewhat available, the available programs usually do not address the unique reactive business processes of each business or any other entity.

Further, business procedures are often not available in an electronic format that is readily available. Business procedures are frequently laid out as a combination of text and figures in various manuals and procedures. However, these business procedures may not be implemented in a timely manner when relying on a non-automated process and alert system.

Further, locating these business procedures requires a positive action by a user who must first know where to locate the business procedures for responding to certain events. When a business that delivers paper fails to deliver a requisite number of boxes to a customer by a certain deadline, certain procedures are ideally implemented in order to address this issue. In such a case, a certain group of responsible individuals may need to be notified in order to address this issue. There may need to be an analysis of current arrangements with the customer to determine whether to alter the existing schedule in order to better suit the customer. In this example, the business relies on a number of people to inform the business of the accomplishments and failures of the business' services.

However, in cases where follow up action is required, businesses may not have planned ahead and established certain reactive business processes. Reactive business processes are, generally, those business processes that are implemented in reaction to a trigger event that causes a need for further action to be taken by the business. When situations arise in a business that call for reactive business processes, without prior planning or forecasting, the business tends to rely on manual and possibly disorganized methods for responding to events and occurrences in the business, which may lead to expensive solutions that could have been avoided. Thus, the available solutions for monitoring a business's performance using performance indicators and managing reactive business processes are largely inadequate.

### SUMMARY

The illustrative embodiments provide a computer implemented method, data processing system, and computer usable program code for managing reactive business processes. In one embodiment, the computer implemented method provides for modeling a set of business processes as pre-defined events in a software process application, wherein the software process application is located on a data processing system. A set of performance indicators are associated to the set of business processes. A set of reactive business processes are modeled, wherein the set of reactive business processes are pre-defined templates included in the software process application. The set of reactive business processes are mapped to the set of performance indicators. The set of performance indicators are monitored and responsive to a trigger from the set of performance indicators, a reactive business process is initiated.

### BRIEF DESCRIPTION OF THE SEVERAL VIEWS OF THE DRAWINGS

FIG. 1 is a pictorial representation of a network of data processing systems in which illustrative embodiments may be implemented.

FIG. 2 is a block diagram of a data processing system in which illustrative embodiments may be implemented.

FIG. 3 is a block diagram of components for managing reactive business processes in accordance with illustrative embodiments.

FIG. 4 is a pictorial representation of sample performance indicators and sample reactive business process templates in accordance with an illustrative embodiment.

FIG. 5 is a sample screen shot for an alert message on a business process application in accordance with an illustrative embodiment.

FIG. 6 is a flowchart describing a method for managing business performance in accordance with an illustrative embodiment.

### DETAILED DESCRIPTION

As will be appreciated by one skilled in the art, the present illustrative embodiments may be embodied as a system, method or computer program product. Accordingly, the present illustrative embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present illustrative embodiments may take the form of a computer program product embodied in any tangible medium of expression having computer usable program code embodied in the medium.

Any combination of one or more computer usable or computer readable medium(s) may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CDROM), an optical storage device, a transmission media such as those supporting the Internet or an intranet, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to wireless, wireline, optical fiber cable, RF, etc.

Computer program code for carrying out operations of the present illustrative embodiments may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The present illustrative embodiments are described below with reference to flowchart illustrations and/or block diagrams of methods, apparatus (systems) and computer program products according to various embodiments. It will be understood that each block of the flowchart illustrations and/or block diagrams, and combinations of blocks in the flowchart illustrations and/or block diagrams, can be implemented by computer program instructions.

These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

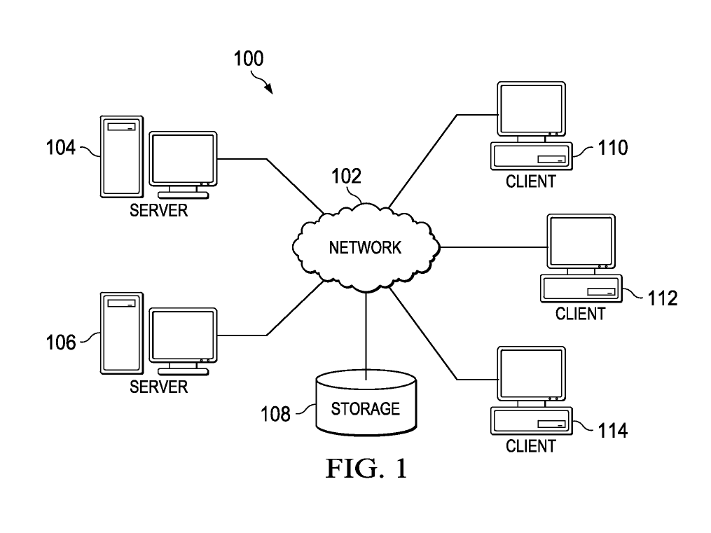

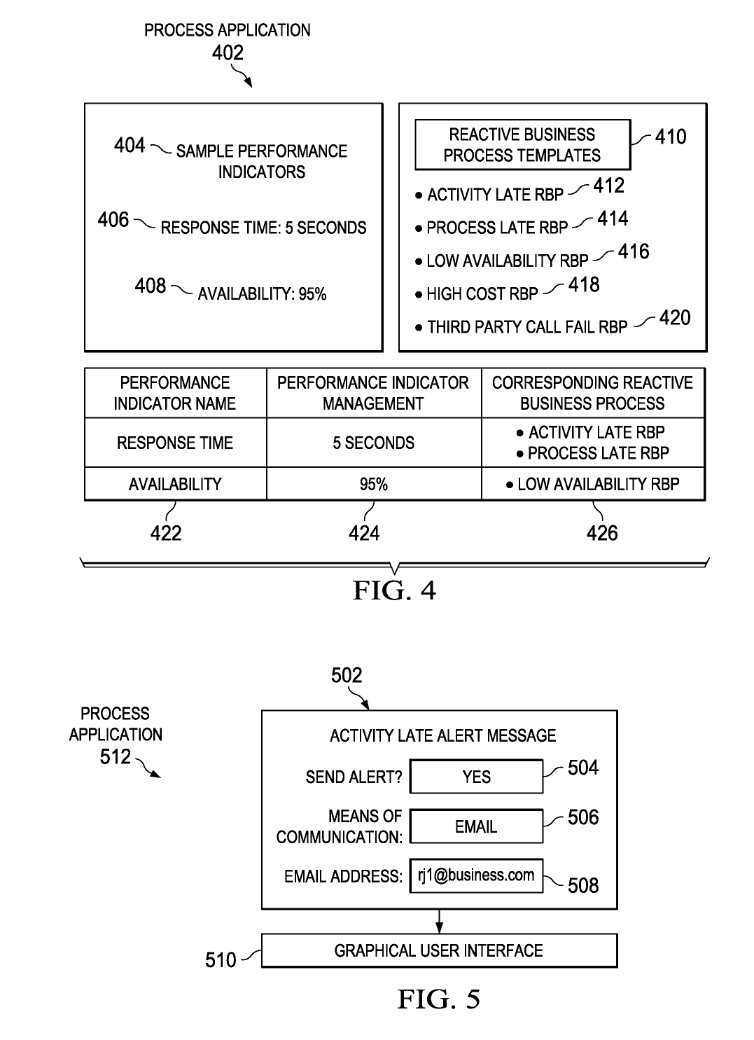

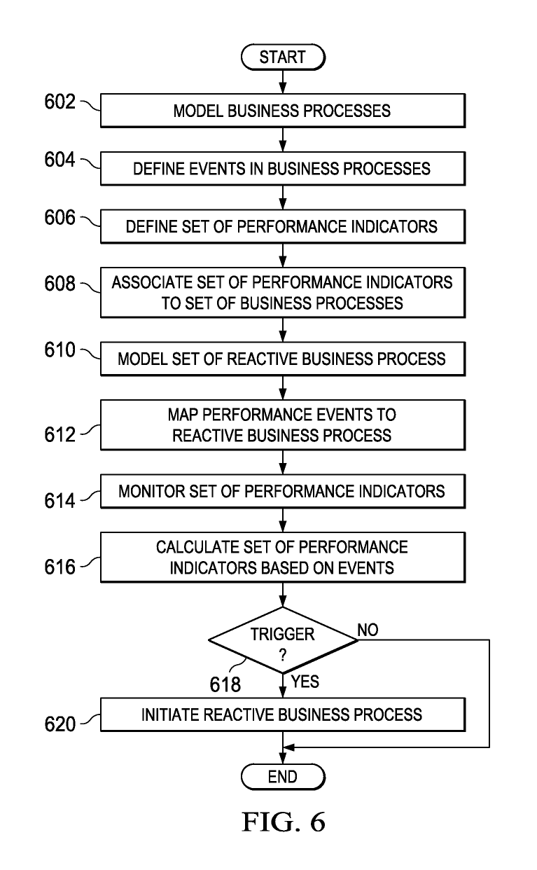

In FIG. 1, network data processing system 100 is a network of computers in which different illustrative embodiments may be implemented. FIG. 1 is intended as an example and not as an architectural limitation for the processes of the different illustrative embodiments. In FIG. 1, network data processing system 100 contains network 102, which is the medium used to provide communications links between various devices and computers connected within network data processing system 100. Network 102 may include permanent or temporary connections, and wireless or land line connections. Network 102 may be utilized as a wireless network set to a pre-defined wireless standard that may transmit wireless signals 420 in FIG. 4 or wireless signals 620 in FIG. 6.

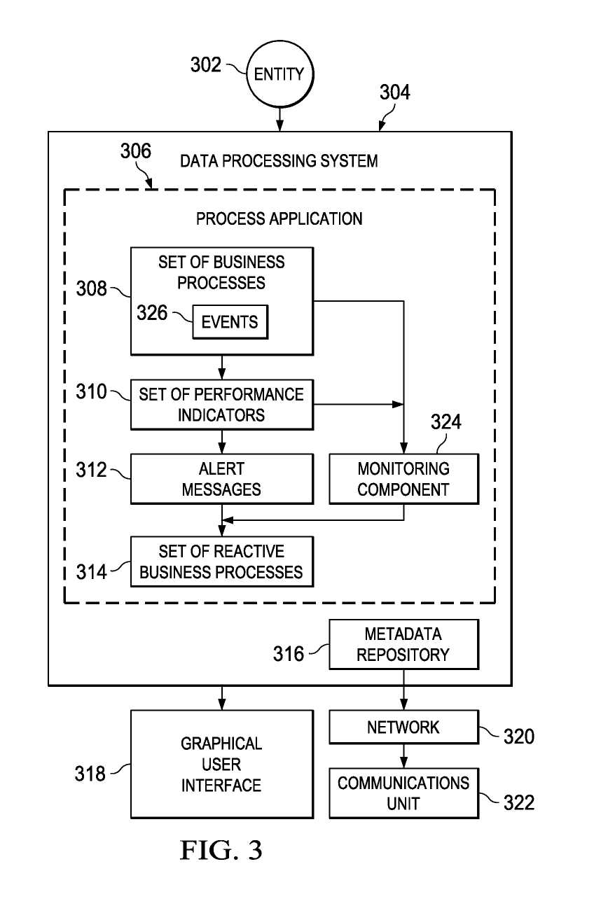

In the depicted example, servers 104 and 106 are connected to network 102, along with storage unit 108. In addition, clients 110, 112 and 114 are also connected to network 102. These clients, 110, 112 and 114, may be, for example, personal computers or network computers. Clients 110, 112, and 114 may be implemented as data processing system 304 in FIG. 3. Further, process application 306 in FIG. 3 and process application 402 in FIG. 4 may be implemented in clients 110, 112, and 114.

In the depicted example, server 104 provides data, such as boot files, operating system images and applications, to clients 110, 112 and 114. Clients 110, 112 and 114 are clients to server 104 and 106. Network data processing system 100 may include additional servers, clients, and other devices not shown.

In the depicted example, networked data processing system 100 is the Internet, with network 102 representing a worldwide collection of networks and gateways that use the TCP/IP suite of protocols to communicate with one another. At the heart of the Internet is a backbone of high-speed data communication lines between major nodes or host computers consisting of thousands of commercial, government, education, and other computer systems that route data and messages. Of course, network data processing system 100 also may be implemented as a number of different types of networks such as, for example, an Intranet or a local area network.

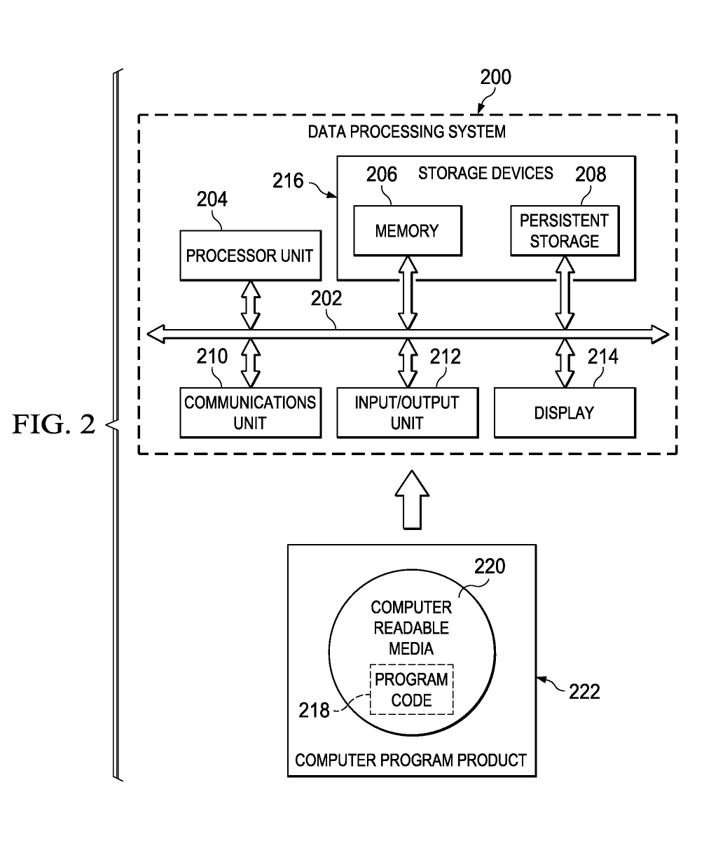

Turning now to FIG. 2, a diagram of a data processing system is depicted in accordance with an illustrative embodiment. In this illustrative example, data processing system 200 includes communications fabric 202, which provides communications between processor unit 204, memory 206, persistent storage 208, communications unit 210, input/output (I/O) unit 212, and display 214.

Processor unit 204 serves to execute instructions for software that may be loaded into memory 206. Processor unit 204 may be a set of one or more processors or may be a multi-processor core, depending on the particular implementation. Further, processor unit 204 may be implemented using one or more heterogeneous processor systems in which a main processor is present with secondary processors on a single chip. As another illustrative example, processor unit 204 may be a symmetric multi-processor system containing multiple processors of the same type.

Memory 206 and persistent storage 208 are examples of storage devices 216. A storage device is any piece of hardware that is capable of storing information, such as, for example without limitation, data, program code in functional form, and/or other suitable information either on a temporary basis and/or a permanent basis. Memory 206, in these examples, may be, for example, a random access memory or any other suitable volatile or non-volatile storage device. Persistent storage 208 may take various forms depending on the particular implementation. For example, persistent storage 208 may contain one or more components or devices. For example, persistent storage 208 may be a hard drive, a flash memory, a rewritable optical disk, a rewritable magnetic tape, or some combination of the above. The media used by persistent storage 208 also may be removable. For example, a removable hard drive may be used for persistent storage 208.

Communications unit 210, in these examples, provides for communications with other data processing systems or devices. In these examples, communications unit 210 is a network interface card. Communications unit 210 may provide communications through the use of either or both physical and wireless communications links.

Input/output unit 212 allows for input and output of data with other devices that may be connected to data processing system 200. For example, input/output unit 212 may provide a connection for user input through a keyboard, a mouse, and/or some other suitable input device. Further, input/output unit 212 may send output to a printer. Display 214 provides a mechanism to display information to a user.

Instructions for the operating system, applications and/or programs may be located in storage devices 216, which are in communication with processor unit 204 through communications fabric 202. In these illustrative examples the instruction are in a functional form on persistent storage 208. These instructions may be loaded into memory x06 for execution by processor unit 204. The processes of the different embodiments may be performed by processor unit 204 using computer implemented instructions, which may be located in a memory, such as memory 206.

These instructions are referred to as program code, computer usable program code, or computer readable program code that may be read and executed by a processor in processor unit 204. The program code in the different embodiments may be embodied on different physical or tangible computer readable media, such as memory 206 or persistent storage 208.

Program code 218 is located in a functional form on computer readable media 220 that is selectively removable and may be loaded onto or transferred to data processing system 200 for execution by processor unit 204. Program code 218 and computer readable media 220 form computer program product 222 in these examples. In one example, computer readable media 220 may be in a tangible form, such as, for example, an optical or magnetic disc that is inserted or placed into a drive or other device that is part of persistent storage 208 for transfer onto a storage device, such as a hard drive that is part of persistent storage 208. In a tangible form, computer readable media 220 also may take the form of a persistent storage, such as a hard drive, a thumb drive, or a flash memory that is connected to data processing system 200. The tangible form of computer readable media 220 is also referred to as computer recordable storage media. In some instances, computer readable media 220 may not be removable.

Alternatively, program code 218 may be transferred to data processing system 200 from computer readable media 220 through a communications link to communications unit 210 and/or through a connection to input/output unit 212. The communications link and/or the connection may be physical or wireless in the illustrative examples. The computer readable media also may take the form of non-tangible media, such as communications links or wireless transmissions containing the program code.

In some illustrative embodiments, program code 218 may be downloaded over a network to persistent storage 208 from another device or data processing system for use within data processing system 200. For instance, program code stored in a computer readable storage medium in a server data processing system may be downloaded over a network from the server to data processing system 200. The data processing system providing program code 218 may be a server computer, a client computer, or some other device capable of storing and transmitting program code 218.

The different components illustrated for data processing system 200 are not meant to provide architectural limitations to the manner in which different embodiments may be implemented. The different illustrative embodiments may be implemented in a data processing system including components in addition to or in place of those illustrated for data processing system 200. Other components shown in FIG. 2 can be varied from the illustrative examples shown. The different embodiments may be implemented using any hardware device or system capable of executing program code. As one example, the data processing system may include organic components integrated with inorganic components and/or may be comprised entirely of organic components excluding a human being. For example, a storage device may be comprised of an organic semiconductor.

As another example, a storage device in data processing system 200 is any hardware apparatus that may store data. Memory 206, persistent storage 208 and computer readable media 220 are examples of storage devices in a tangible form.

In another example, a bus system may be used to implement communications fabric 202 and may be comprised of one or more buses, such as a system bus or an input/output bus. Of course, the bus system may be implemented using any suitable type of architecture that provides for a transfer of data between different components or devices attached to the bus system. Additionally, a communications unit may include one or more devices used to transmit and receive data, such as a modem or a network adapter. Further, a memory may be, for example, memory 206 or a cache such as found in an interface and memory controller hub that may be present in communications fabric 202.

As previously described, the current solutions for implementing reactive business processes are largely inadequate. Reactive business processes are usually a process or procedure implemented in response to an event or occurrence in a business. The reactive business process exists in situations in which follow up action is needed by a set of responsible individuals and/or a system. The term “set”, as used herein, refers to at least one or more. A set of responsible individuals may be located in the business itself. However, the set of responsible individuals will require assistance in determining which reactive business processes to implement to respond to an event or occurrence. A need exists for assisting businesses to know both when and what are the appropriate steps to take when a situation arises in a business that requires a reactive business process to be implemented.

A services oriented architecture (SOA) structure is needed to monitor the services that a business provides and to monitor that performance targets are met, including response time, availability, and cost. A template-based SOA governance system is thus needed to ensure that business performance targets are met and to ensure corrective reactive business processes are properly implemented.

Therefore, the illustrative embodiments recognize a computer-implemented method, computer program product, and data processing system for managing reactive business processes. In accordance with an illustrative embodiment, the computer implemented method provides for modeling a set of business processes as pre-defined events in a software process application, wherein the software process application is located on a data processing system. A set of performance indicators are associated to the set of business processes. A set of reactive business processes are modeled, wherein the set of reactive business processes are pre-defined templates included in the software process application. The set of reactive business processes are mapped to the set of performance indicators. The set of performance indicators are monitored and responsive to a trigger from the set of performance indicators, a reactive business process is initiated.

In an illustrative embodiment, the set of business processes are modeled in a computer software application and tied to a set of performance indicators. The set of performance indicators correspond to values used to measure against a set of criteria relevant to a business. The set of performance indicators may relate to the services and/or products offered by a business. The set of performance indicators may also relate to internal tasks and internal processes critical to the operation of the business.

The set of reactive business processes are included in the computer software application as templates that may be customized by a user of the business. The set of reactive business processes include pre-defined templates. However, the pre-defined templates are customizable to the needs of each entity. Responsive to creating the set of reactive business processes, the set of performance indicators are mapped and stored to the set of reactive business processes. For example purposes only, and without limitation, when a business fails to produce a product for production in time with a deadline, a performance indicator that is used to monitor this event will trigger a reactive business process. The reactive business process may include an alert sent to a responsible party notifying the responsible party of the failure.

Turning to FIG. 3, a block diagram of components for managing reactive business processes is presented in accordance with illustrative embodiments. In FIG. 3, data processing system 304 is a data processing system that may be implemented using, without limitation, the components in FIG. 2. Data processing system 304 may be a server computer, a client computer, or some other device capable of storing and transmitting program code, such as program code 218 in FIG. 2.

Entity 302 may be any type of business, corporation, or organization, whether for profit or not for profit. In one embodiment, entity 302 is a business that includes various business processes, performance indicators, and reactive business processes that may be modeled and monitored using process application 306.

Process application 306 is a software application located on data processing system 304. Process application 306 is used by entity 302 to manage business processes and reactive business processes in an automated manner on data processing system 304. In one embodiment, process application 306 may be implemented using various types of programming languages, including but not limited to Java™ C™, C++™, or scripts.

Metadata repository 316 is included in FIG. 3. Metadata repository 316 may be implemented, without limitation, as a relational database management system (RDBMS), extensible markup language (XML), or as a flat file database. A flat file database describes any of various means to encode a database model, and is usually in the form of a table. In a flat file database, data is usually arranged in a single table, with all records in identical field structures, and stacked together in rows and columns to form a large table similar to a spreadsheet. Usually, a flat file is a plain text file, which usually contains one record per line.

In a preferred embodiment, metadata repository 316 is implemented as a relational database management system (RDBMS). A relational database management system manages databases on a relational basis. The individual databases are in the form of flat files. A relational database management system (RDBMS) is able to maintain a database based on relationships between data items.

A relational database, such as metadata repository 316, is a collection of data files that relate to each other through at least one common field. The common field serves as a thread throughout the various files. In a relational database consisting of rows and columns in a table, each row contains a single data record, and each column contains all instances of each row for one specific piece of data.

Metadata repository 316 may be implemented as a relational database management system (RDBMS). Metadata repository 316 may be used to collect and store data about set of business processes 308 and set of performance indicators 310. Metadata repository 316 may be used to collect and store data about set of reactive business processes 314. Metadata repository 316 may be implemented in multiple frameworks and systems as part of a services oriented architecture (SOA) that processes data in order to assist in the governance of an entity's set of business processes. As part of the SOA governance, process application 306 is designed to be easily configurable to multiple operating systems and to co-exist with various applications on a data processing system.

Set of business processes 308 may be any normal business processes associated with entity 302. Set of business processes 308 may be processes and procedures related to operation of personnel and the internal operations of entity 302. Set of business processes 308 may also be processes and procedures developed specifically for services and products relevant to entity 302. In FIG. 3, set of business processes 308 are modeled in process application 306. The modeling of set of business processes 308 may be performed using graphic notations, programming code, text, or a combination of all the above. The purpose of modeling is to computerize a sequence of events that reflect important elements of a business process. In order to model set of business processes 308, events 326 are defined in set of business processes 308. Events 326 in set of business processes 308 are tied to a set of performance indicators, such as set of performance indicators 310. Events 326 may be any occurrence pertinent to a business process.

Set of business processes 308 may be entered into process application 306 using any input tools and techniques as is commonly known by one of ordinary skill in the art. Set of business processes 308 may comprise a database entry format whereby set of business processes 308 are inputted into fields with specific titles.

Process application 306 provides to a user a series of prompts requesting information regarding set of business processes 308 for entity 302. Thus, process application 306 includes a method and system for modeling set of business processes 308 as events that are associated with set of performance indicators 310.

Set of performance indicators 310 are a set of performance indicators as previously described. Set of performance indicators 310 are values used to measure against set of business processes 308. The values belonging to performance indicators 310 act as threshold values to compare against and to verify whether the objectives and target goals of certain business processes are being met. Set of performance indicators 310 are usually quantifiable and measurable. Raw sets of values may be used to feed into process application 306 to represent set of performance indicators 310. For example purposes only and without limitation, a sample set of performance indicators, such as set of performance indicators 310, may refer to the number of units shipped, sold, or manufactured or may be determined based on the total amount of dollars produced for a certain number of units. Set of performance indicators 310 may vary for different types of entities, such as entity 302.

Set of performance indicators 310 may also be referred to by another term known in the art. Set of performance indicators 310 may also be known as key performance indicators. Key performance indicators are quantifiable measurements, designed by entity 302, that reflect the critical success factors of an organization.

Entity 302 may organize and select set of performance indicators 310 once entity 302 has identified important criteria used to define and measure progress towards organizational goals, including but not limited to, its goals, its mission, its stakeholders, and its customers.

Set of performance indicators 310 will differ depending on each organization. For example, a business may have as a performance indicator from among set of performance indicators 310 the percentage of its income that comes from return customers. As another example, a school may focus its performance indicators on graduation rates of its students. As another example, a customer service department may have as one of its performance indicators, a percentage of customer calls answered in the first minute. A performance indicator for a social service organization might be number of clients assisted during the year. Ultimately, set of performance indicators 310 should reflect the organization's goals, be key to its success, and should be quantifiable and measurable. Set of performance indicators 310 may be altered to continually suit the requirements of entity 302.

A benefit of the method included for process application 306 is that every entity may tailor set of performance indicators 310 to process application 306 in a way that best suits the goals of the entity, such as entity 302. A school is not concerned with making a profit, and thus, the set of performance indicators associated with a school will probably be different than that of a set of performance indicators associated with a business interested in measuring profit and related fiscal measures. Thus, if entity 302 is a school utilizing process application 306, the school may have key performance indicators such as “graduation rate” and “success in finding employment after graduation.”

As another example of set of performance indicators 310, if a company's performance indicator is to “increase customer satisfaction,” an important performance indicator may be “number of units rejected by quality inspection” or “minutes a customer is on hold before a sales representation answers.” The values corresponding to these sample performance indicators are measurable and quantifiable indicators used by a company to determine how to maximize customer satisfaction.

Set of business processes 308 may be associated with set of performance indicators 310. Thus, if a business process is determined to be to “sell 20 units per day,” then a performance indicator that will need a corresponding entry in process application 306 may be “number of units sold per day.”

Set of reactive business processes 314 refer to a set of reactive business processes modeled in process application 306. Set of reactive business processes 314 refer to those procedures and processes implemented by entity 302 based on values provided for set of performance indicators 310. Reactive business processes are processes and procedures implemented by entity 302 to respond to occurrences associated with set of performance indicators 310. Templates may be included in process application 306 for a user to set up the fields and elements for set of reactive business processes 314. These templates may be pre-defined or may also be developed by entity 302. Set of reactive business processes 314 are presented to a user or set of users on a graphical user interface, such as graphical user interface 318. Graphical user interface 318 may be any sort of known or available visual interface and associated tools to interact with graphical user interface 318.

Examples of reactive business processes may be seen in FIG. 4. Referring again to FIG. 3, reactive business processes 314 may include, without limitation, any actions triggered as a response to a set of performance indicators including, processes and procedures for responding to late activities within entity 302, high cost, low availability, and failure to contact certain individuals. Set of reactive business processes 314 communicate to a user or other responsible party at entity 302 relevant and appropriate actions for responding to information provided by set of performance indicators 310.

Set of performance indicators 310 may be utilized as a record or log of various events or processes associated with entity 302. In one embodiment, information related to set of performance indicators 310 may be inputted by users in process application 306. Values associated with set of performance indicators 310 may also be inputted through various software applications and systems.

Set of reactive business processes 314 may respond to both a failure and/or success in achieving a threshold target set of values for set of performance indicators 310. Entity 302 may have a set of process and procedures that correspond to preferred actions and follow up procedures, responsive to achieving a target set of values associated with set of performance indicators 310. Set of reactive business processes 314 are mapped to set of performance indicators 310.

Monitoring component 324 is a component of process application 306 that monitors the sets of values associated with set of performance indicators 310. Process application 306 may be configured whereby set of performance indicators 310 does not trigger a reactive business process until a threshold value is reached. Monitoring component 324 may initiate set of reactive business processes 314 responsive to a trigger from set of performance indicators 310. The monitoring configuration data is stored in metadata repository 316 as well as monitoring output data.

In one embodiment, alert messages 312 are messages containing relevant information regarding set of performance indicators 310 in process application 306. Alert messages 312 provide information to the recipient about an event or situation that is monitored and measured using set of performance indicators 310. Alert messages 312 may notify responsible individuals within entity 302 of certain results for set of performance indicators 310. Thus, responsive to a threshold set of values for set of performance indicators 310, alert messages 312 may be transmitted to either responsible individuals in entity 302 or to a system or both. Alert messages 312 may be communicated through a variety of methods to communications unit 322. Alert messages 312 may be transmitted via e-mail (electronic mail), telephone, faxing, text messages, or any combination of the above. Alert messages 312 may be transmitted over network 320 to communications unit 322. Communications unit 322 may be, without limitation, a telephone, an e-mail software application located on a data processing system, a fax machine, a mobile device, a PDA, or any type of unit known available for communication to either a person or a system. Network 320 is any type of network needed for connecting information from data processing system 304 to network 320. An example of alert message 312 may be seen in FIG. 5 as activity late alert message 502.

Referring again to FIG. 3, alert messages 312 may be configured as part of the configuration for entity 302 of process application 306, when the set of reactive business processes 314 are initially configured. In one embodiment, alert messages 312 are transmitted to a set of responsible individuals associated with entity 302 so as to alert the responsible party about a specific performance indicator from set of performance indicators 310. Alert messages 312 may also be submitted to a system in order to trigger a necessary reaction.

In accordance with an illustrative embodiment, process application 306 can be configured by entity 302 at any time to model set of business processes 308. Set of performance indicators 310 are determined by users at entity 302. Set of performance indicators 310 are measurable and quantifiable indicators that may receive sets of values that may be stored on data storage 316. Set of performance indicators 310 are mapped to set of reactive business processes 314. Monitoring component 324 monitors set of performance indicators 310 to determine when an associated set of reactive business processes should be triggered. Alert messages 312 may be transmitted to responsible individuals or to elements of a system as part of set of reactive business processes 314.

Thus, process application 306 provides for a platform independent, services oriented architecture (SOA) that allows for correct implementation of reactive business model templates based on a set of performance indicators that have reached a certain threshold. Prior solutions have not described a services oriented architecture (SOA) that facilitates mapping a set of performance indicators, such as set of performance indicators 310 to a set of reactive business processes, such as set of reactive business processes 314.

Accordingly, in one embodiment, entity 302 may use process application 306 to model business processes. Set of business processes 308 may be modeled in process application 306 as events. Events 326 are tied to set of business processes 308 as occurrences important to a business process.

Set of performance indicators 310 are associated with set of business processes 308. In a preferred embodiment, metadata repository 316 stores the structure for set of performance indicators 310 as a relational database management system. Metadata repository 316 may be used to store and collect information regarding set of performance indicators.

Further, set of reactive business processes 314 are modeled. Set of reactive business processes 314 may be customizable templates that include information about a set of reactive business processes. Reactive business processes are processes and procedures implemented by entity 302 to respond to occurrences associated with set of performance indicators 310. Templates may be included in process application 306 for a user to set up the fields and elements for set of reactive business processes 314. These templates may be pre-defined or may also be developed completely by entity 302.

Set of reactive business processes 314 is mapped to set of performance indicators 310. Metadata repository 316 is used to store the information regarding the mapping of set of reactive business processes 314 to set of performance indicators 310.

Monitoring component 324 monitors as fields belonging to set of performance indicators 310 are updated with values or other information. Upon reaching a threshold value or trigger point, monitoring component 324 is configured to initiate a reactive business process from set of reactive business processes 314. Set of reactive business process 314 may include pertinent information for alerting a responsible party or system component. An alert may be provided to a responsible party or system component through communications unit 322. The alert may include relevant information regarding set of performance indicators 310. The alert may also include relevant information about a corresponding reactive business process and the necessary steps that need to be resolved or need attention.

For example purposes only, a business process for a bank may be, “handle a personal loan application.” This process can happen when a customer applies for loan by phone, email, online or walking-in to a branch. The bank can set the process to take the information, check credit history, check customer relationship, approve or disapprove loan, get signatures, issue a check, setup repayment process, etc. The performance indicator could be “respond the customer with approve/disapprove within 4 business hours after the application is received and issue the check with 8 business hours after approval.” The reactive process, if the clerk fails to approve/disapprove with 4 hours, may be to send an email to the manager and create a late indicator in database. Another reactive process could be add a task to another clerk to finish the process.

FIG. 4 is a pictorial representation of sample performance indicators and sample reactive business process templates in accordance with an illustrative embodiment. Process application 402 is a software application that implements the illustrative embodiments for associating a set of reactive business processes to a set of performance indicators for an entity. Process application 402 may be implemented as process application 306 in FIG. 3.

Sample performance indicators 404 are sample performance indicators that a user may have inputted into process application 402. As previously described in FIG. 3, performance indicators are a set of values that are used to measure against set of business processes 308. In FIG. 4, an example of a performance indicator is response time 406 and availability 408. In this particular example, the performance indicator determines that a critical response time is five seconds for 406 and a critical percentage of availability is ninety five percent for 408.

Reactive business process templates 410 are templates for reactive business processes as described for set of reactive business processes 314 in FIG. 3. Reactive business process templates 410 are sample templates that may be included in process application 402. Sample reactive business process templates may include, without limitation, templates for late activity 412, templates for late processes 414, templates for low availability 416, templates for high cost 418, and templates for a failure to call a third party 420. These templates correspond to set of performance indicators that are used by an entity, such as entity 302 in FIG. 3, to monitor the performance of the entity.

Accordingly, corresponding reactive business processes 426 include sample reactive business processes that are prompted to a user for configuration responsive to configuring performance indicators. Part of the configuration of performance indicators includes configuring the associated title or name, as seen by 422, and a set of values used to provide relevant information about an entity, such as the set of values provided in 424.

FIG. 4 is used as an example of screen shots and fields that may be utilized by process application 402. However, multiple methods of presentation and interfacing with a user may be implemented by one of ordinary skill in the art to enter and monitor data related to performance indicators and templates for reactive business processes on process application 402.

FIG. 5 is a sample screen shot for a business process application in accordance with an illustrative embodiment. FIG. 5 depicts an alert message that may be configured by a user for notifying a responsible party when activity critical to an entity is late. In accordance with one embodiment, a user utilizes process application 512 to configure activity late alert message 502. A determination is made to send an alert message at 504. The user is provided with the option whether to send an alert message, such as 502. The user in FIG. 5 chooses to send an alert message and to use e-mail as the means of communication regarding the late activity at 506. Activity late alert message 502 enables a user to enter an email address for transmitting an alert message. All of the information related to 504, 506, and 508 may be presented to a user on graphical user interface 510.

Activity late alert message 502 is an example of alert messages 312 in FIG. 3 that may be transmitted over a network, such as network 320, to a communications unit. Communications unit 322 in FIG. 3 is an e-mail application capable of receiving and transmitting e-mails. In FIG. 5, an alert message is provided to a user regarding a late activity. Activity late alert message 502 may contain relevant information regarding the late activity as well as the reactive business process and procedures specified by an entity as how to react to the late activity. Activity late alert message 502 may contain information in the email relating to the performance indicators that triggered the alert message as well as further instructions designed as part of a set of reactive business processes developed by an entity.

In FIG. 6, a flowchart describing a method for managing business performance is depicted in accordance with an illustrative embodiment. The method described in FIG. 6 may be implemented utilizing the respective components in FIG. 3. Thus, the method described in FIG. 6 may be implemented using process application 306 on data processing system 304.

In accordance with an illustrative embodiment, a set of business processes are modeled in a process application (step 602). The process application may be a process application such as process application 306, process application 402, and process application 512. A process application is used to model a set of business processes in a software application located on a data processing system. An entity utilizes a process application to model the set of business processes.

A set of relevant events for an entity's business processes are defined in a process application (step 604). Defining relevant events to an entity in process application may be performed using a graphical user interface and relevant tools on a data processing system.

As part of the method, in accordance with an illustrative embodiment, a set of performance indicators are defined (step 606). The set of performance indicators may be a set of performance indicators as seen in FIG. 3 at 310 and in FIG. 4 at 404. The set of performance indicators are associated to a set of business processes (step 608). A set of reactive business processes are modeled (step 610). The set of reactive business processes are mapped to the performance events that were defined in step 604 (step 612). The set of reactive business processes may be tied to the set of reactive business processes and stored in a metadata repository. Values relevant to the set of performance indicators may be inputted into the fields associated with the set of performance indicators on process application.

The set of performance indicators are monitored (step 614). The monitoring of the set of performance indicators may be monitored using a monitoring component of a software application, such as monitoring component 324 in FIG. 3.

At step 616, the set of performance indicators are calculated based on the metadata associated with the defined events from step 604. A determination is made whether a trigger condition occurred to initiate a reactive business process (step 618). Responsive to an occurrence of a trigger condition indicating that a reactive business process should be initiated, a corresponding reactive business process to a performance indicator is initiated (step 620). However, if no trigger condition occurs for initiating a reactive business process, the method terminates thereafter.

Therefore, the illustrative embodiments provide for a computer implemented method, data processing system, and computer usable program code for managing reactive business processes. In one embodiment, the computer implemented method provides for modeling a set of business processes as pre-defined events in a software process application, wherein the software process application is located on a data processing system. A set of performance indicators are associated to the set of business processes. A set of reactive business processes are modeled, wherein the set of reactive business processes are pre-defined templates included in the software process application. The set of reactive business processes are mapped to the set of performance indicators. The set of performance indicators are monitored and responsive to a trigger from the set of performance indicators, a reactive business process is initiated.

The benefits of the illustrative embodiments are numerous. A process application in accordance with the illustrative embodiments is developed in order to allow an entity to manage business processes by tying performance indicators, which are commonly used, to a set of reactive business processes in a more organized and efficient manner on a data processing system than what is currently available. The illustrative embodiments assist an entity to achieve greater organization by providing a tool that allows an entity to anticipate critical performance indicators that are key to meeting goals and the successes of an entity.

Further, the illustrative embodiments allow for an automated process for monitoring the set of performance indicators and for notifying responsible individuals relevant information about the set of performance indicators in a timely manner. Oftentimes, businesses lose opportunities because the businesses are not notified about critical aspects in a timely manner. The illustrative embodiments disclose a method for associating the performance indicators with a set of reactive business processes that an entity prepares in anticipation of important events and a method for communicating this set of reactive business processes to corresponding recipients.

The flowchart and block diagrams in the Figures illustrate the architecture, functionality, and operation of possible implementations of systems, methods and computer program products according to various embodiments. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present illustrative embodiments has been presented for purposes of illustration and description, but is not intended to be exhaustive or limited to the embodiments disclosed herein. Many modifications and variations will be apparent to those of ordinary skill in the art without departing from the scope and spirit of the illustrative embodiments. The illustrative embodiments are chosen and described in order to best explain the principles of the disclosed ideas and the practical application thereof, and to enable others of ordinary skill in the art to understand the various embodiments with various modifications as are suited to the particular use contemplated.

The illustrative embodiments can take the form of an entirely hardware embodiment, an entirely software embodiment or an embodiment containing both hardware and software elements. In a preferred embodiment, the illustrative embodiments are implemented in software, which includes but is not limited to firmware, resident software, microcode, etc.

Furthermore, the illustrative embodiments can take the form of a computer program product accessible from a computer-usable or computer-readable medium providing program code for use by or in connection with a computer or any instruction execution system. For the purposes of this description, a computer-usable or computer readable medium can be any tangible apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

The description of the present illustrative embodiments has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A computer implemented method for managing reactive business processes, the computer implemented method comprising:
modeling a set of business processes as pre-defined events in a software process application, wherein the software process application is located on a data processing system;
associating a set of performance indicators to the set of business processes;
modeling a set of reactive business processes, wherein the set of reactive business processes are templates included in the software process application that reflect processes based on the set of performance indicators;
mapping the set of reactive business processes to the set of pre-defined events;
monitoring the set of performance indicators; and
responsive to a trigger from the set of performance indicators, initiating one or more reactive business processes.

2. The computer implemented method of claim 1, wherein initiating the reactive business process further comprises:
sending an alert message to a system or to a set of responsible individuals.

3. The computer implemented method of claim 2, wherein the alert message is provided by a communications medium, wherein the communications medium comprises at least one of a telephone call, e-mail, fax, or text message to the system or the responsible individual.

4. The computer implemented method of claim 1, wherein a monitoring component is used to determine whether to initiate the reactive business process.

5. The computer implemented method of claim 1, wherein the set of performance indicators define a set of values used as a measure against the set of business processes.

6. The computer implemented method of claim 1, wherein the set of reactive business processes comprise business processes for implementation responsive to a failure of meeting a performance indicator from the set of performance indicators.

7. A computer implemented method for managing business performance based on reactive business processes, the computer implemented method comprising:
modeling a set of business processes as pre-defined events in a software process application, wherein the software process application is located on a data processing system, wherein the software process application comprises templates for events and functions within a business;
associating a set of performance indicators to the set of business processes, wherein the set of business processes are modeled in the software process application;
modeling a set of reactive business processes, wherein the set of reactive business processes are pre-defined templates included in the software process application;
mapping the set of reactive business processes to the set of pre-defined events, wherein the set of reactive business processes comprise business processes for implementation responsive to a failure of meeting a performance indicator from the set of performance indicators;
monitoring the set of performance indicators; and
responsive to a trigger from the set of performance indicators, initiating one or more reactive business process, wherein initiating a reactive business process further comprises:
sending an alert message to a set of responsible individuals, wherein the alert message is provided by a communications medium, wherein the communications medium comprises at least one of a telephone call, e-mail, fax, or text message to the set of responsible individuals, and wherein the alert message is an indication that a corresponding performance indicator was not met.

8. A computer program product stored on a recordable type computer readable medium for managing business performance based on reactive business processes, the computer program product comprising:
computer program code for modeling a set of business processes as pre-defined events in a software process application, wherein the software process application is located on a data processing system;
computer program code for associating a set of performance indicators to the set of business processes;
computer program code for modeling a set of reactive business processes, wherein the set of reactive business processes are pre-defined templates included in the software process application;
computer program code for mapping the set of reactive business processes to the set of performance indicators;
computer program code for monitoring the set of performance indicators; and
computer program code for, responsive to a trigger from the set of performance indicators, initiating one or more reactive business process.

9. The computer program product of claim 8, wherein initiating the reactive business process further comprises:
sending an alert message to a system or to a responsible individual.

10. The computer program product of claim 9, wherein the alert message is provided by a communications medium, wherein the communications medium comprises at least one of a telephone call, e-mail, fax, or text message to the system or the responsible individual.

11. The computer program product of claim 8, wherein a metadata repository is used to store the mapping between the set of performance indicators and corresponding reactive business processes.

12. The computer program product of claim 8, wherein the set of performance indicators define a set of values used as a measure against the set of business processes.

13. The computer implemented method of claim 8, wherein the set of reactive business processes comprise business processes for implementation responsive to a failure of meeting a performance indicator from the set of performance indicators.

14. A data processing system for managing business performance based on reactive business processes, the data processing system comprising:
a bus system;
a communications system connected to the bus system;
a memory connected to the bus system, wherein the memory includes a set of instructions; and
a processing unit connected to the bus system, wherein the processing unit executes the set of instructions:
to model a set of business processes as pre-defined events in a software process application, wherein the software process application is located on a data processing system;
to associate a set of performance indicators to the set of business processes;
to model a set of reactive business processes, wherein the set of reactive business processes are pre-defined templates included in the software process application;
to map the set of reactive business processes to the set of predefined events;
to monitor the set of performance indicators; and
to initiate one or more reactive business process responsive to a trigger from the set of performance indicators.

15. The data processing system of claim 14, wherein initiating the reactive business process further comprises:
sending an alert message to a system or to a responsible individual.

16. The data processing system of claim 15, wherein the alert message is provided by a communications medium, wherein the communications medium comprises at least one of a telephone call, e-mail, fax, or text message to the system or the responsible individual.

17. The data processing system of claim 14, wherein a metadata repository is used to store the mapping between the set of performance indicators and corresponding reactive business processes.

18. The data processing system of claim 14, wherein the set of performance indicators define a set of values used as a measure against the set of business processes.

19. The data processing system of claim 14, wherein the set of reactive business processes comprise business processes for implementation responsive to a failure of meeting a performance indicator from the set of performance indicators.

20. The data processing system of claim 14, wherein the data processing system further comprises a graphical user interface for modeling the set of business processes and the set of reactive business processes in the software process application.
